(19) United States
(12) Patent Application Publication
(10) Pub. No.: US 2012/0218396 A1
(43) Pub. Date: Aug. 30, 2012

(54) METHOD AND APPARATUS FOR USABILITY TESTING OF A MOBILE DEVICE

(75) Inventor: DARRELL BENATAR, PALO ALTO, CA (US)

(73) Assignee: USERTESTING, INC., Mountain View, CA (US)

(21) Appl. No.: 13/404,828

(22) Filed: Feb. 24, 2012

Related U.S. Application Data
(60) Provisional application No. 61/463,903, filed on Feb. 24, 2011.

(51) Int. Cl. H04N 7/18

(52) U.S. Cl. 348/77; 348/E07.085

(57) ABSTRACT

A method and apparatus for usability testing a mobile device. The method and apparatus display a usability testing script on a computer screen of a user computer, capture video of a mobile device while a user is using the mobile device in accordance with the usability testing script, create a recording data file comprising at least the video, and send the recording data file to a data collection computer.

### CROSS-REFERENCE TO RELATED APPLICATIONS

This application claims benefit of U.S. provisional patent application Ser. No. 61/463,903 filed Feb. 24, 2011, which is herein incorporated by reference in its entirety.

### BACKGROUND

1. Field of the Invention

The present invention relates to usability testing and, more particularly, to a automated method and apparatus for conducting usability testing for mobile devices.

2. Description of the Related Art

Usability testing is a process through which a product is utilized while the user is monitored. The usability testing professional may desire to conduct a usability test on, for example, a certain feature or aspect of an application, a software program, a web site design, and/or create a training video and documentation, etc. having a user interface supported by a mobile device. Although the procedures for conducting tests on these products may vary from one professional to another, a key aspect of the test is to understand what a user does and does not do relating to that feature or aspect of the product.

A common testing scenario is as follows: The professional (which will now be referred to as the moderator) obtains test subjects or users to test the usability of the product. The users are then asked to perform certain tasks related to, for example, the application, the web site, the software program, etc. having a user interface on a mobile device. During this process, the moderator observes the users and takes notes about the performance of the users and the issues that arise. In some instances, the moderator may also utilize video equipment and/or other specialized equipment to record device interaction, facial expressions and audio of the users. Upon completion, the moderator compiles highlight videos to provide their developers and engineers with supporting evidence of what issues exist with the program or why users do certain actions. Typically, summary and detailed reports of these tests are also prepared and statistical analysis, graphs, charts, and other data is produced.

While these usability tests are useful tools to the professionals, the cost of labor (moderators), equipment, facilities rental, and the like, makes such testing very expensive. Additional costs arise from recruiting test participants, paying incentives to test participants, and the like.

Therefore there is a need in the art for an automated, unmoderated method and apparatus for conducting usability testing of a mobile device.

### SUMMARY OF THE INVENTION

Embodiments of the present invention include a method and apparatus for usability testing a mobile device, including the device itself, applications executing on the device and/or websites being displayed on the device. The method and apparatus display a usability testing script on a computer screen of a user computer, capture video of a mobile device while a user is using the mobile device in accordance with the usability testing script, create a recording data file comprising at least the video, and send the recording data file to a data collection computer. The method may also capture audio as the usability test is performed.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a diagram illustrating a system for performing usability testing of a mobile device in accordance with at least one embodiment of the present invention.

FIG. 2 is a flowchart illustrating a method for performing usability testing of a mobile device in accordance with at least one embodiment of the present invention.

FIG. 3 is a flowchart illustrating a method for creating usability test results of a mobile device in accordance with at least one embodiment of the present invention.

FIG. 4. is a block diagram depicting a mobile device and a user computer 50 in accordance with embodiments of the present invention in accordance at least one embodiment of the present invention.

### DETAILED DESCRIPTION

Embodiments of the present invention comprise a user computer executing a usability testing software application that displays a usability testing script to a user. While the user uses a mobile device in accordance with the script, a camera operating in combination with the user computer captures video of the user using the mobile device. The video forms a portion of a recording data file that is sent from the user computer to a data collection computer. The data collection computer may aggregate the data recording files from a number of user computers and then analyze the aggregate files. In this manner, usability testing of a mobile device (including testing of the device itself, an application executing on the device and/or a website being displayed and utilized on the device) is performed in an unmoderated, automatic fashion.

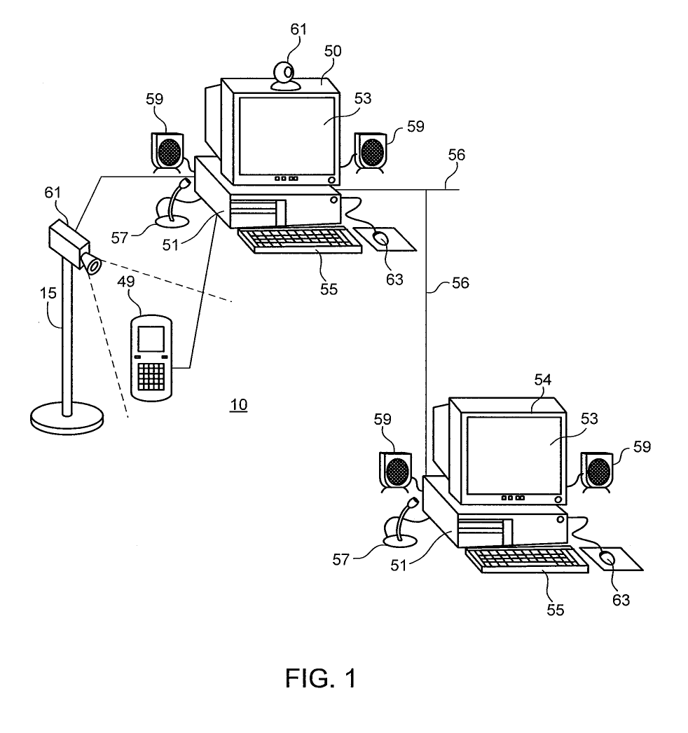

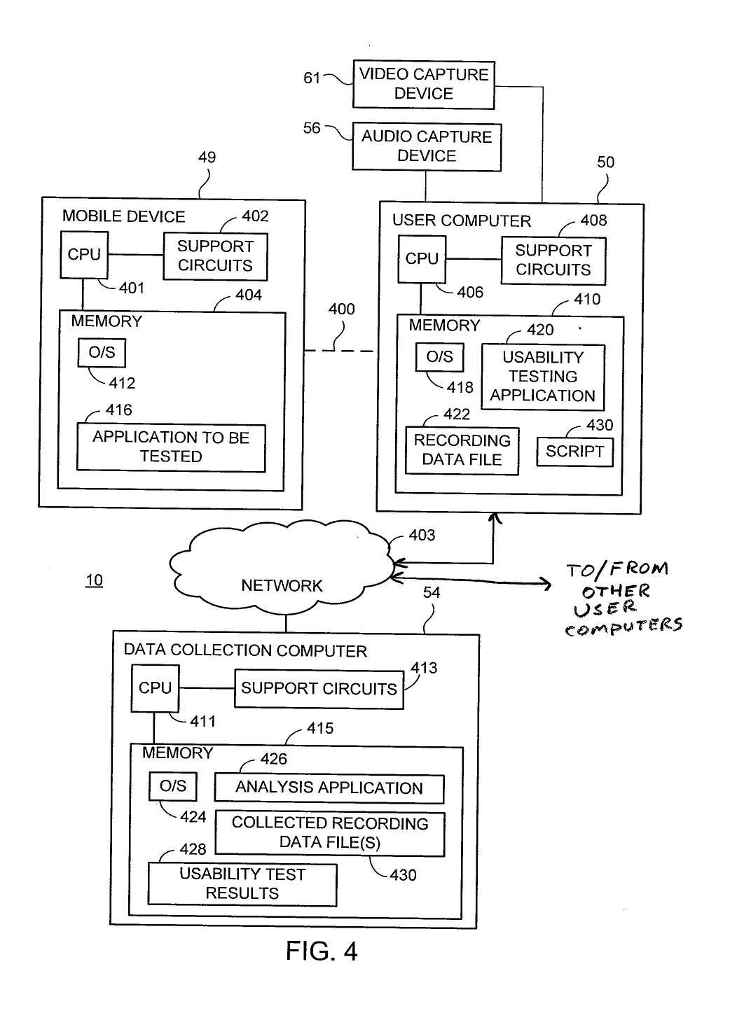

FIG. 1 depicts a usability testing system 10 comprising a mobile device 49, a user computer 50, and a manager computer 54, with each connected to one another over a network connection 56 such as a local area network (LAN) or a wide area network (WAN). The mobile device 49 is of a type that is commonly known in the art, such as a smart phone, a cellular phone, a pager, pad computer, tablet computer, personal digital assistant (PDA) and the like. The mobile device 49 may or may not be coupled to the user computer 50. The user computer 50 comprises some or all of a central processing unit 51, a computer screen 53, a keyboard 55, a mouse 63, a microphone 57, speakers 59, and a video capture device 61 (e.g., video camera, a web camera and the like). In one embodiment, the video capture device 61 is arranged to view the mobile device 49 while a user is using the mobile device. In some embodiments, the video capture device 61 may be mounted on stand 15 overlooking the mobile device 49. In other embodiments, the video capture device 61 may be held by the user or the video capture device may be mounted on the user (e.g., a shoulder mount). The interaction between the mobile device 49 and the user computer 50 is described further with respect to FIG. 4.

The data collection computer 54 comprises of a similar central processing unit 51, the computer screen 53, the keyboard 55, and the mouse 63. The manager computer 54 may also comprise a microphone 57 and speakers 59. Computers and their components are well known in the art and it is contemplated that any compatible type, version, or size made by any manufacturer is acceptable to accomplish the intended purposes of the embodiments of the invention described herein. The computers 50 and 54 may be general purpose computers that operate as specific purpose computers when executing software used to implement the invention, as described below.

In some embodiments, the user computer 50 executes a usability testing application that displays a test procedure (script) to the user. The video capture device 61 records the video of the user and the mobile device in use and the audio capture device 57 (e.g., a microphone) is used to record the utterances of the user. In some embodiments, the video capture device 57 and/or video capture device 61 record the user throughout usability testing of the mobile device. In one embodiment, a script is displayed on the computer screen 53 and, while the user performs the scripted operations (e.g., use the device, execute an application and/or interact with a website displayed on the device) the video capture device 61 records the use of the mobile device 49.

In some embodiments, the audio may be captured via a telephone, wherein the user calls a specific telephone number via an Internet call or a standard telephone call. Once connected, the user may describe/comment on their experience with the mobile device and be recorded on a remotely located recording device. The communication is recorded as an audio recording.

In some embodiments, the usability testing system 10 may record text and images displayed on the mobile device 49, input operations performed on the mobile device 49, and application events. The application events may include operating system events and application events. Operating system events include but are not limited to opening and closing main application windows, smaller windows appearing within the main window (dialog boxes, alerts, etc.), menus, buttons appearing on dialogs or windows, launch of applications and other window related objects such as slider bars, list views, edit boxes, and the like. Application events include, but are not limited to, data entry, information display, interface manipulation and the like. In one embodiment, these events are sent from the mobile device to the computer via a data connection such as USB. In other embodiments, the occurrence of an event may be captured in the video as the event is displayed on the screen of the mobile device.

Upon completion of testing, the video/audio data (recording data) is sent from the user computer to the data collection computer 54. If the audio was recorded separately, the separate audio and video files may be merged to form a single multimedia file either before or after transmission to the data collection computer. At the data collection computer, recording data from a plurality of user computers is aggregated and analyzed. In one embodiment, a compilation of annotated multi-media information is created as a multi-media report for a customer that requested the usability testing.

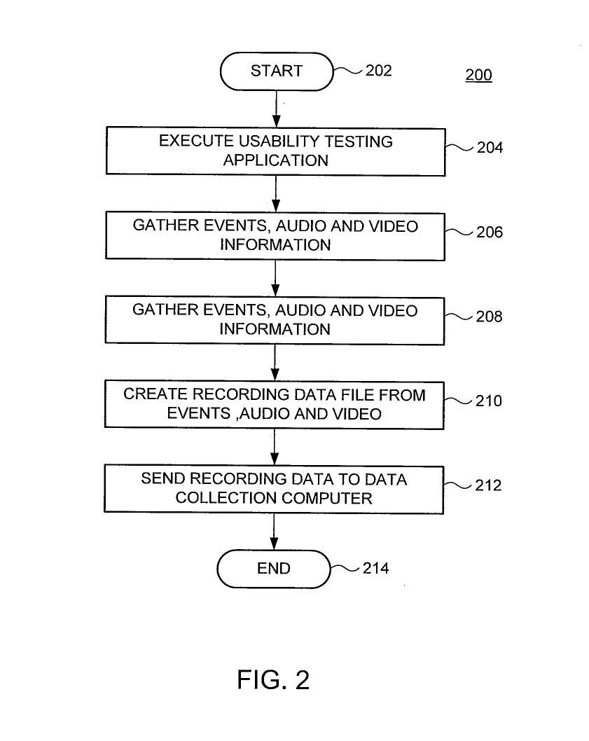

FIG. 2 depicts a flow diagram of a method 200 for performing usability testing of a mobile device in accordance with embodiments of the invention. The method 200 begins at step 202 and proceeds to step 204. At step 204, the user computer executes a usability testing application. At step 206, the user computer displays a usability test script on the computer screen. The script comprises a series of tasks to be performed by the user on the mobile device (e.g., tasks to operate the device itself, to execute and use an application, and/or to interact with a website displayed on the device). The user, while following the script, is recorded using the camera/microphone. Thus, while using the mobile device, the user may add audio annotations regarding usability of the mobile device, e.g., state difficulties in use. If the user is to record audio via a telephone, the script may contain the telephone number to be called. Users are prescreened for their ability to continuously verbalize their thoughts while using the mobile device. The prescreened users form a pool of candidate users. Particular users are selected from the pool based upon a demographic profile deemed required to accurately test the mobile device. Typically, a plurality of users is selected to test a given mobile device to provide enough data to perform statistical analyses regarding the usability test.

At step 208, the method 200 gathers audio information and video information pertaining to a usability test of a mobile device as described above with respect to FIG. 1. In some embodiments, event information may be captured if the mobile device is coupled to the user computer. Such event information may be as simple as capturing the time the mobile device was connected to the computer as an indication that the test is ready to begin. The display on the computer screen may comprise recording controls (e.g., recording and/or test start/stop button(s)). When the user manipulates the recording controls (e.g., selects a start recording button), the video is recorded by the camera and coupled to the user computer. After gathering audio, and video information (and, optionally, event information), the method 200 proceeds to step 210.

At step 210, the method 200 creates a recording data file comprising the audio information and video information (and optional event information). In some embodiments, the event information, audio information, and video information are received as a plurality of data streams or files that are then combined into a single file or data structure. After generating the recording data file, the method 200 proceeds to step 212.

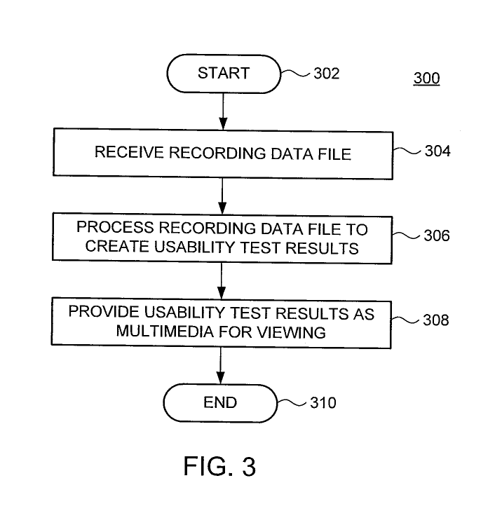

At step 212, the method 200 sends the generated recording data file to a data collection computer, such as the computer 54 described with respect to FIG. 1 and FIG. 4. The data collection computer is responsible for processing the recording data into an output format representing the results of the usability test. The process by which the data collection computer creates the results is described further with respect to FIG. 3. After sending the recording data file, the method 200 ends at step 214.

FIG. 3 depicts a flow diagram of a method 300 for creating usability testing results for a mobile device in accordance with embodiments of the invention. The method 300 may be performed by a computer such as the data collection computer 54 described with respect to FIG. 1 and FIG. 4. In some embodiments, the method 300 is performed by an analysis application 426 as described with respect to FIG. 4.

The method 300 begins at step 302 and proceeds to step 304. At step 304, the method 300 receives a recording data file, such as a transmission of a recording data file from the user computer as described with respect to FIG. 2. After receiving the recording data file, the method 300 proceeds to step 306. At step 306, the method 300 processes the recording data file to produce usability test results. The processing step 306 may include allowing a test manager to aggregate a plurality of recording data files from a plurality of user computers, edit and/or annotate the recording data file(s), such as specifying markers on the video at particular times or screen locations, highlighting various interface events, emphasizing particular audio comments, and the like. Such edits and/or annotations are made for the purpose of highlighting particular user interactions during use of the software application and/or website. These edits and annotations allow for easier dissemination of information to the party reviewing the usability test results to determine which elements of the device or application the user had positive and/or negative reactions. After processing the recording data to create usability test results, the method 300 proceeds to step 308.

At step 308, the method 300 provides the processed usability test results as a multimedia file. In some embodiments, the recording data file as processed at step 306 is encoded into a multimedia format for playing on a software multimedia player as known in the art. In some embodiments, the multimedia file is directly sent as a file, CD, or DVD to a customer who requested the test. In some embodiments, the video is hosted on a server, such as the data collection computer 54, and viewed by the customer via an embedded multimedia player. After converting the usability test results to a multimedia format and providing the multimedia file, the method 300 ends at step 310.

FIG. 4. depicts a block diagram of a usability testing apparatus 10 for performing usability testing of a mobile device or application executed on a mobile device in accordance with embodiments of the present invention. The system comprises a mobile device 49, a user computer 50, and a data collection computer 54. The mobile device 49 may be coupled to the user computer 50 by an optional link 400. The link may be any coupling mechanism as commonly known in the art, such as a universal serial bus (USB) cable, BLUETOOTH wireless, a cellular link, any of the 802.11 family of wireless protocols, and the like. Such a link 400 may be optionally used to capture events (e.g., button manipulation) on the mobile device 49.

The user computer 50 is coupled to the data collection computer 54 via a network 403. In some embodiments, the network 403 is a local network. In some embodiments, the network 403 is a wide area packet switched network, such as the Internet. The user computer 50 is configured to transmit a recording data file 422 relating to a usability test performed with respect to the mobile device 49 to the data collection computer 54. In some embodiments, the mobile device 49 is optionally coupled to the network 403. A network connection for the mobile device 49 may be established by one or more well-known methods such as a wired connection, 802.11x network protocols, “3G” or “4G” networks, WIMAX, and the like.

The mobile device 49 comprises a CPU 401, a plurality of support circuits 402, and a memory 404. The support circuits 402 may include a display device as well as other circuits to support the functionality of the CPU 401. Such support circuits 402 may also include clock circuits, cache, power supplies, network cards, video circuits, display, keypad and the like.

The memory 404 may comprise read only memory, random access memory, removable memory, disk drives, optical drives and/or other forms of digital storage. The memory 404 is configured to store an operating system 412 and, if testing is related to an application and not the hardware itself, an application to be tested 416. The operating system 412 executes to control the general operation of the mobile device 49 including facilitating the execution of various processes, applications, and modules to perform specific tasks.

The application to be tested 416 is an application with an interface as described above with respect to FIGS. 2-3. The application to be tested 416 may be a browser accessing a particular web page, or, in some embodiments, the application to be tested 416 is a particular mobile device application that provides functionality to the mobile device.

The user computer 50 serves to provide a platform for execution of usability testing of the mobile device 49. The user computer 50 comprises a CPU 406, a plurality of support circuits 408, and a memory 410. The support circuits 408 may include a display device as well as other circuits to support the functionality of the CPU 406. Such support circuits 408 may also include clock circuits, cache, power supplies, network cards, video circuits and the like. In addition, the user computer 50 is coupled to a video capture device 61 such as a video camera or webcam, and an audio capture device 57 such as a microphone. In some embodiments, the audio capture device may be a headset or handset coupled to the computer and used to place voice over Internet Protocol (VOIP) calls via the computer. In other instances, the audio capture device may be a telephone used to place a call through plain old telephone system (POTS) lines. In either embodiment, the call is recorded at a remote location.

The memory 410 may comprise read only memory, random access memory, removable memory, disk drives, optical drives and/or other forms of digital storage. The memory 410 is configured to store an operating system 418 and a usability testing application 420. The operating system 418 executes to control the general operation of the user computer 50 including facilitating the execution of various processes, applications, and modules to perform specific tasks. In some embodiments, the usability testing application 420 receives data from the mobile device 49 sent across the link 400, and subsequently transmits the received data to the data collection computer 54 as a portion of a recording data file 422. The usability testing application 420 displays a script 430. The script 430 comprises instructions/tasks for the user to perform while using the mobile device 49. During use of the mobile device 49, video and audio are captured and stored as a portion of the recording data file 422. In one embodiment, the audio may be captured separately at the data collection computer 54 via a telephone connection. In an alternative embodiment, the usability testing application 420 may record events regarding the mobile device 49 synchronized with both the video and audio of the user. The recording data file 422 optionally includes a chronicle of events that occur behind the scenes in the applications and the operating system as provided by the mobile device 49. Such a recording data file 422 may include audio, video, and/or interface input operations as recorded by the usability testing application 414.

The data collection computer 54 provides a platform for processing of recording data to generate usability test results. The data collection computer 54 comprises a CPU 411, a plurality of support circuits 413, and a memory 415. The support circuits 408 may include a display device as well as other circuits to support the functionality of the CPU 406. Such support circuits 408 may also include clock circuits, cache, power supplies, network cards, video circuits and the like.

The memory 415 may comprise read only memory, random access memory, removable memory, disk drives, optical drives and/or other forms of digital storage. The memory 415 is configured to store an operating system 424, an analysis application 426, at least one collected recording data file 430, and usability test results 428. The operating system 424 executes to control the general operation of the data collection computer 54 including facilitating the execution of various processes, applications, and modules to perform specific tasks. The analysis application 426 operates to receive recording data files 422 from the user computer 50, store the recording data file 422 as the at least one collected recording data file 430, analyze the at least one collected recording data file 430, and create usability test results 428. The recording data file 422 may be aggregated and/or combined with data files from other user computers to form the collected recording data files 430. The analysis application 426 further provides a test professional with the ability to edit and/or annotate the collected recording data files 430 to highlight or reference particular events or data for analysis within the usability test results 428. The analysis application 428 may also provide for encoding of the recording data and any edits/annotations into a video format for viewing by a customer. The video may be sent to the customer as a separate file, or it may be hosted on the data collection computer 54 for remote viewing.

Embodiments of the invention may be used in a number of variants to the concepts described above, including using a camera that is embedded in a laptop computer lid as the video capture device. To facilitate use of this camera, the laptop may be rotated to face away from the tester, while the mobile device is held in the view of the camera and the tester. The script displayed on the laptop screen may be viewed via a mirror placed in front of the screen or on the mobile device using a mirroring feature to link the laptop screen and the mobile device screen. In other embodiments, the mirroring feature may be used to align the camera and mobile device, then, mirroring is disabled and the application or website to be tested is executed on the mobile device. Usability testing would then continue as described above.

Thus, there has been provided a unique automated, unmoderated method and apparatus for conducting usability testing of a mobile device. While the invention has been described in conjunction with a specific embodiment, it is evident that many alternatives, modifications and variations will be apparent to those skilled in the art in light of the foregoing description. Accordingly, it in intended to embrace all such alternatives, modifications and variations as fall within the spirit and scope of the invention.

The foregoing description of embodiments of the invention comprises a number of elements, devices, circuits, and/or assemblies that perform various functions as described. These elements, devices, circuits and/or assemblies are exemplary implementations of means for performing their respectively described functions.

1. Apparatus for usability testing of mobile devices comprising:
a video capture device for capturing video of a user while the user is using a mobile device;
a user computer, coupled to the video capture device, for displaying a usability testing script that is to be followed by the user as the mobile device is used and for creating a recording data file comprising the video.

2. The apparatus of claim 1 further comprising:
an audio capture device for capturing utterances of the user while the user is using the mobile device in accordance with the usability testing script.

3. The apparatus of claim 2 wherein the audio capture device is at least one of a microphone coupled to the user computer or a telephone.

4. The apparatus of claim 1, further comprising:
a data collection computer for receiving the recording data file and analyzing the recording data file.

5. The method of claim 1 wherein the recording data file comprises the audio.

6. The apparatus of claim 1 wherein the user computer controls the video capture device.

7. The apparatus of claim 1 wherein the mobile device comprises a smart phone, a cellular phone, a pager, pad computer, tablet computer, or personal digital assistant (PDA).

8. A computer implemented method of usability testing a mobile device comprising:
displaying a usability testing script on a computer screen of a user computer;
capturing video of a mobile device while a user is using the mobile device in accordance with the usability testing script;
creating a recording data file comprising at least the video; and
sending the recording data file to a data collection computer.

9. The method of claim 8 wherein capturing comprises positioning a video capture device to view the mobile device and coupling the video to a user computer.

10. The method of claim 8 further comprising capturing audio comprising utterances made by the user while using the mobile device in accordance with the testing script.

11. The method of claim 8 wherein the recording data file comprises the audio.

12. The method of claim 8 wherein the audio capture device is at least one of a microphone coupled to the user computer or a telephone.

13. The method of claim 8 wherein the mobile device comprises a smart phone, a cellular phone, a pager, pad computer, tablet computer, or personal digital assistant (PDA).

14. The method of claim 8 wherein the usability testing script comprises instructions regarding the use of at least one of the mobile device, an application executing on the mobile device or a website being displayed on the mobile device.

15. A non-transient storage medium for storing computer instructions that, when executed by a processor, cause the processor to perform a method comprising:
displaying a usability testing script on a computer screen of a user computer;
capturing video of a mobile device while a user is using the mobile device in accordance with the usability testing script;
creating a recording data file comprising at least the video; and
sending the recording data file to a data collection computer.

16. The method of claim 15 wherein capturing comprises positioning a video capture device to view the mobile device and coupling the video to a user computer.

17. The method of claim 15 further comprising capturing audio comprising utterances made by the user while using the mobile device in accordance with the testing script.

18. The method of claim 15 wherein the recording data file comprises the audio.

19. The method of claim 15 wherein the audio capture device is at least one of a microphone coupled to the user computer or a telephone.

20. The method of claim 15 wherein the mobile device comprises a smart phone, a cellular phone, a pager, pad computer, tablet computer, or personal digital assistant (PDA).
